(19) United States
(12) Patent Application Publication
(10) Pub. No.: US 2025/0276399 A1
(43) Pub. Date: Sep. 4, 2025

(54) NARROW-GAP/ULTRA-NARROW-GAP MAG/MIG WELDING GUN AND NOZZLE THEREOF

(71) Applicant: CHINA CONSTRUCTION STEEL STRUCTURE CO., LTD., Shenzhen (CN)

(72) Inventors: Peng WANG, Shenzhen (CN); Qingchuan FENG, Shenzhen (CN); Zhiyong ZUO, Shenzhen (CN); Fuju ZHANG, Shenzhen (CN); Yufei WANG, Shenzhen (CN); Jiangtao LIU, Shenzhen (CN); Xiao HUANG, Shenzhen (CN)

(73) Assignee: CHINA CONSTRUCTION STEEL STRUCTURE CO., LTD., Shenzhen (CN)

(21) Appl. No.: 18/805,226

(22) Filed: Aug. 14, 2024

(30) Foreign Application Priority Data
Feb. 29, 2024 (CN) 202410230252.7

(51) Int. Cl. B23K 9/26

(52) U.S. Cl. CPC B23K 9/26

(57) ABSTRACT

The present disclosure discloses a narrow-gap/ultra-narrow-gap MAG/MIG welding gun and a nozzle thereof. According to the nozzle for the narrow-gap/ultra-narrow-gap MAG/MIG welding gun, a top end of the nozzle is configured to be connected to a bottom end of a welding gun body, and a vertical section of a bottom end portion of the nozzle is a trapezoidal section with a large upper side and a small lower side. In this way, it is convenient to observe a molten pool and an arc from two sides of a height direction of the nozzle.

### TECHNICAL FIELD

The present disclosure relates to the technical field of welding guns, in particular to a narrow-gap/ultra-narrow-gap MAG/MIG welding gun and a nozzle thereof.

### BACKGROUND

Since the introduction of narrow-gap MAG/MIG welding in the 1970s, in its welding gun structure, in order to avoid a gas electrical conductivity between an electrically conductive tube and welding grooves (welded base material) in two very close side walls, i.e., achieve insulation between the electrically conductive tube and the welding grooves, the following six techniques are usually adopted: 1. The insulation between the electrically conductive tube and the welding grooves is achieved by using a metal nozzle outside the electrically conductive tube, and spraying ceramics on an outer surface of the metal nozzle. 2. The insulation between the electrically conductive tube and the welding grooves is achieved by using a metal nozzle outside the electrically conductive tube, and pasting high-temperature-resistant insulation tape outside the metal nozzle. 3. The insulation between the electrically conductive tube and the welding grooves is achieved by coating the electrically conductive tube with an insulation material. 4. A nozzle is made of a structural ceramic material outside the electrically conductive tube, and the insulation between the electrically conductive tube and the welding grooves is achieved through the ceramic nozzle with a good electrical insulation property. 5. Special flux bands are arranged immediately close to the grooves in the two side walls, and the insulation between the electrically conductive tube and the welding grooves is achieved by using a non-conductive property of the flux bands. 6. A part of a gun body that conducts a welding current of the electrically conductive tube is made of metal, a part of the gun body that transmits a primary shielding gas is also made of metal, and insulation between the metal materials of the two parts is performed with an electrical insulation material.

For example, a Chinese patent document ZL201810399746.2 discloses an ultra-narrow-gap MAG/MIG automatic welding gun metal nozzle insulated from an electrically conductive tube. A Chinese patent document ZL201710973362.2 discloses an ultra-narrow-gap MAG/MIG welding electrically conductive tube with surface insulation. A Chinese patent document ZL202111639833.9 discloses a ceramic nozzle based on split narrow-gap MAG/MIG automatic welding and a use method thereof. A Chinese patent document ZL201510359894.8 discloses an assembled ultra-narrow-gap MAG/MIG welding insulation nozzle. A Chinese patent document ZL201610932718.3 discloses a life-extension method for a narrow-gap gas shielded welding ceramic nozzle based on a refractory metal composite. A Chinese patent document ZL201610931688.4 discloses a life-extension apparatus and life-extension method for a narrow-gap gas shielded welding ceramic nozzle.

However, the welding gun structures disclosed in the above Chinese patent documents all suffer from a defect that a molten pool cannot be easily observed.

Therefore, there is a great need to design a new narrow-gap/ultra-narrow-gap MAG/MIG welding gun and a nozzle thereof to overcome the above defect.

### SUMMARY OF THE INVENTION

Therefore, a technical problem to be solved by the present disclosure lies in that with an existing narrow-gap MAG/MIG welding gun structure, a molten pool cannot be easily observed, and thus a narrow-gap/ultra-narrow-gap MAG/MIG welding gun and a nozzle thereof are provided.

In order to solve the above technical problem, a technical solution of the present disclosure is as follows.

According to a nozzle for a narrow-gap/ultra-narrow-gap MAG/MIG welding gun, a top end of the nozzle is configured to be connected to a bottom end of a welding gun body, and a vertical section of a bottom end portion of the nozzle is a trapezoidal section with a large upper side and a small lower side.

Further, the nozzle includes a first nozzle and a second nozzle, and the first nozzle and the second nozzle are aligned and joined together.

Further, the first nozzle and the second nozzle are provided with a first electrically conductive tube cavity and a second electrically conductive tube cavity respectively in respective inner ends thereof, the first electrically conductive tube cavity and the second electrically conductive tube cavity are aligned and joined to form an electrically conductive tube accommodation slot, and the electrically conductive tube accommodation slot penetrates through the nozzle along an up-and-down direction.

Further, a tail end of the nozzle is concave towards a direction of the welding gun body to form a concave area, and the electrically conductive tube accommodation slot downwardly communicates with the concave area.

Further, a height H of the nozzle is 23 mm, a length S of a long bottom side of the trapezoidal section is 50 mm, and a length P of a short bottom side is 30 mm, or, the height H of the nozzle is 28 mm, the length S of the long bottom side of the trapezoidal section is 75 mm, and the length P of the short bottom side is 36 mm.

Further, the nozzle is a structural ceramic nozzle.

Further, a screw-bolt unthreaded hole in the first nozzle and a screw-bolt unthreaded hole in the second nozzle penetrate upwardly through the first nozzle and the second nozzle respectively, and downwardly communicate with corresponding screw-bolt operation holes, and a hole diameter of the screw-bolt operation holes is larger than a hole diameter of the screw-bolt unthreaded holes.

The technical solution of the present disclosure has following advantages.
1. According to the nozzle for the narrow-gap/ultra-narrow-gap MAG/MIG welding gun, the top end of the nozzle is configured to be connected to the bottom end of the welding gun body, and the vertical section of the bottom end portion of the nozzle is the trapezoidal section with the large upper side and the small lower side. In this way, it is convenient to observe a molten pool and an arc from two sides of a height direction of the nozzle.
2. According to the nozzle for the narrow-gap/ultra-narrow-gap MAG/MIG welding gun, the tail end of the nozzle is concave towards the direction of the welding gun body to form the concave area, and the electrically conductive tube accommodation slot communicates with the concave area. In this way, a distance between the tail end of the nozzle and the arc at a high temperature of thousands of degrees may be reduced, thus a risk of high temperature ablation of the nozzle is reduced, and the service life of the nozzle is prolonged.
3. According to the nozzle for the narrow-gap/ultra-narrow-gap MAG/MIG welding gun, the screw-bolt unthreaded hole in the first nozzle and the screw-bolt unthreaded hole in the second nozzle penetrate upwardly through the first nozzle and the second nozzle respectively, and downwardly communicate with the corresponding screw-bolt operation holes, and the hole diameter of the screw-bolt operation holes is larger than the hole diameter of the screw-bolt unthreaded holes. In this way, it can not only be convenient for screw bolts to pass through the screw-bolt operation holes to enter the screw-bolt unthreaded holes so as to realize a firm connection between the nozzle and the welding gun body, but also enable a reliable insulation isolation between the screw bolts made of a metal material and a welded metal base material at two groove side walls, so as to reliably prevent a contact short circuit between heads of the screw bolts and the two welding groove side walls and the generation of a phenomenon of bypass discharge.
4. According to the nozzle for the narrow-gap/ultra-narrow-gap MAG/MIG welding gun, the nozzle is the structural ceramic nozzle. In this way, a high-temperature insulation property of the nozzle is more reliable, even if a tracking accuracy of the welding gun to a center of a weld seam deviates, and abnormal slight contact friction occurs between the nozzle and the two groove side walls, there will not be any failure of an insulation layer which leads to a phenomenon of a short circuit of the welding gun, and the risk of the short circuit of the welding gun is eradicated. Moreover, within a full width range of the nozzle, even if the nozzle is extremely close to the grooves in the two side walls, there is absolutely no electrical conductivity due to ionization of a high temperature gas at a short distance, and thus the risk of bypass discharge of the welding gun is eradicated. Furthermore, due to properties of the structural ceramic material itself, the service life of the nozzle may also be prolonged.

A narrow-gap/ultra-narrow-gap MAG/MIG welding gun includes:
a welding gun body; and
a nozzle. A top end of the nozzle is connected to a bottom end of the welding gun body, and a vertical section of a bottom end portion of the nozzle is a trapezoidal section with a large upper side and a small lower side.

Further, the narrow-gap/ultra-narrow-gap MAG/MIG welding gun further includes an electrically conductive tube. An electrically conductive tube accommodation slot is formed in the nozzle. A radial clearance between the electrically conductive tube and a slot wall of the electrically conductive tube accommodation slot is greater than 0.1 mm.

Further, the nozzle and the welding gun body are connected together by a tenon structure.

The technical solution of the present disclosure has following advantages.
1. The narrow-gap/ultra-narrow-gap MAG/MIG welding gun provided by the present disclosure includes the welding gun body and the nozzle. The top end of the nozzle is connected to the bottom end of the welding gun body, and the vertical section of the bottom end portion of the nozzle is the trapezoidal section with the large upper side and the small lower side. In this way, it is convenient to observe a molten pool and an arc from two sides of a height direction of the nozzle.
2. According to the narrow-gap/ultra-narrow-gap MAG/MIG welding gun provided by the present disclosure, the radial clearance between the electrically conductive tube and the slot wall of the electrically conductive tube accommodation slot is greater than 0.1 mm. In this way, it may be avoided that there is no ceramic layer for isolation outside the electrically conductive tube, and it may also be avoided that when a thermal expansion coefficient of a material of the electrically conductive tube is larger than that of the ceramic material, a thermal expansion of the electrically conductive tube will expand and crack the ceramic nozzle, which leads to a failure of an insulation function of the ceramic nozzle.
3. According to the narrow-gap/ultra-narrow-gap MAG/MIG welding gun provided by the present disclosure, the nozzle and the welding gun body abut against each other together by the tenon structure. In this way, it may be ensured that vertical sections of the welding gun body and the nozzle coincide. At the same time, the presence of the tenon structure enables the welding gun body and the nozzle to be staggered and partially coincide, which may reduce the risk of a leakage of a primary shielding gas from a connection position of the welding gun body and the nozzle.

### BRIEF DESCRIPTION OF THE DRAWINGS

In order to more clearly illustrate technical solutions in specific implementations of the present disclosure or the prior art, accompanying drawings that need to be used in the description of the specific implementations or the prior art will be briefly introduced below. It is obvious that the accompanying drawings in the following description show some implementations of the present disclosure, and for those of ordinary skill in the art, other accompanying drawings may further be obtained according to these accompanying drawings without creative work.

FIG. 1 is a schematic side view of a narrow-gap/ultra-narrow-gap MAG/MIG welding gun welding a weldment under protection of a primary shielding gas in an embodiment of the present disclosure.

FIG. 2 is a schematic sectional view of a first nozzle in an embodiment of the present disclosure.

FIG. 3 is a schematic top view of a combination of a first nozzle and a second nozzle in an embodiment of the present disclosure.

FIG. 4 is a schematic bottom view of a first nozzle in an embodiment of the present disclosure.

FIG. 5 is a schematic diagram of a side combination of a nozzle and a welding gun body in an embodiment of the present disclosure.

FIG. 6 is a schematic diagram of a front combination of a nozzle and a welding gun body in an embodiment of the present disclosure.

FIG. 7 is a schematic top sectional view of a welding gun body in the present disclosure.

### DESCRIPTION OF REFERENCE NUMERALS

1, welding gun body; 2, first nozzle; 21, first electrically conductive tube cavity; 3, second nozzle; 4, primary shielding gas; 5, welding wire; 6, arc; 7, molten pool; 8, first nozzle fixedly coupled position; 9, second nozzle fixedly coupled position; 10, primary gas guide chamber; 11, primary gas inlet; 12, screw-bolt unthreaded hole; 13, screw-bolt operation hole; 14, tenon structure; 15, primary gas flow homogenizing screen; 16, concave area; 17, cold-drawn pipe; and 18, platy structure.

### DETAILED DESCRIPTION

A technical solution of the present disclosure will be clearly and completely described below in conjunction with accompanying drawings. Apparently, described embodiments are part of embodiments of the present disclosure, not all of them. Based on the embodiments in the present disclosure, all other embodiments obtained by those of ordinary skill in the art without creative work shall fall within the protection scope of the present disclosure.

In the description of the present disclosure, it needs to be noted that orientations or position relationships indicated by terms such as “center”, “on”, “below”, “left”, “right”, “vertical”, “horizontal”, “inside” and “outside” are orientations or position relationships shown based on the accompanying drawings, and are used only for facilitating the description of the present disclosure and for simplifying the description, rather than indicating or implying that a mentioned apparatus or element must have a particular orientation or must be constructed and operated in a particular orientation, thus cannot be understood as a limitation on the present disclosure. In addition, terms “first”, “second”, and “third” are used only for the purpose of description, and cannot be understood as indicating or implying relative importance.

In the description of the present disclosure, it needs to be noted that, unless otherwise expressly specified and limited, terms “mounted”, “connected”, and “connection” should be understood in a broad sense, for example, as a fixed connection, as a detachable connection, or as an integral connection; as a mechanical connection, or as an electrical connection; and as a direct connection, as an indirect connection through an intermediate medium, and as communication within two elements. For those of ordinary skill in the art, the specific meanings of the above terms in the present disclosure may be understood to specific circumstances.

Furthermore, technical features involved in the different implementations of the present disclosure described below may be combined with each other as long as they do not constitute a conflict with each other.

The background of the design of the present disclosure is that during a welding process using a narrow-gap/ultra-narrow-gap MAG/MIG welding gun, the observation of a molten pool and an arc is very inconvenient due to a narrow gap, especially when welding is performed at ultra-narrow welding grooves in a large thick plate and an ultra-thick plate.

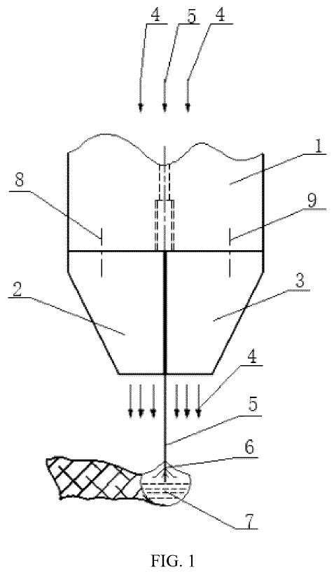

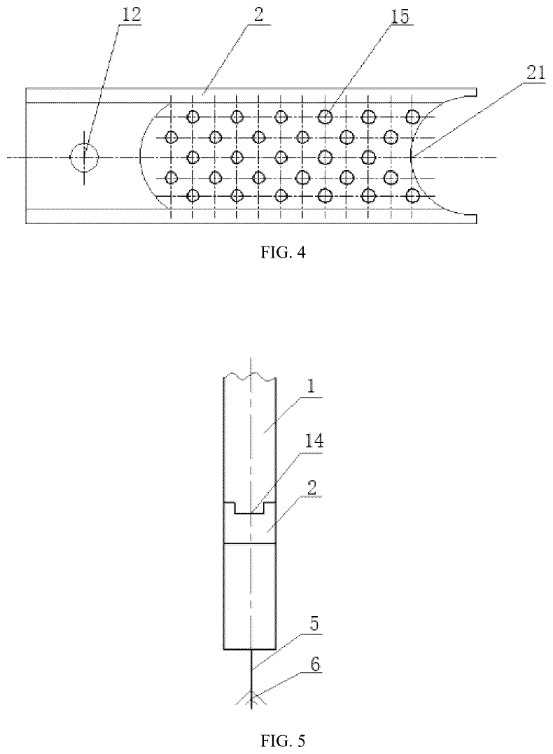

As shown in FIG. 1 to FIG. 7, the present disclosure provides a narrow-gap/ultra-narrow-gap MAG/MIG welding gun, including a welding gun body 1 and a nozzle.

A primary gas guide chamber 10 and a primary gas inlet 11 are formed in the nozzle. The nozzle is further provided with a primary gas flow homogenizing screen 15 and a concave area 16.

The welding gun body 1 is of a composite structure. The so-called “composite structure” means that the middle of the welding gun body 1 is a main body formed by a plurality of cold-drawn pipes 17 in close rows, platy structures 18 for reinforcement and made of the same material are respectively arranged at two ends of the main body, and insulation layers made of a polytetrafluoroethylene material are arranged on surfaces of the main body and the platy structures 18. The cold-drawn pipes 17 are connected and sealed, as well as the two cold-drawn pipes 17 on the outer side and the corresponding platy structures 18 are connected and sealed with Cu—Ag brazing.

The nozzle includes a first nozzle 2 and a second nozzle 3 that are aligned and joined together in a length direction of the nozzle (as in a direction of an arrow A-A in FIG. 3). The first nozzle 2 and the second nozzle 3 are aligned and joined to form an alignment face, and a vertical centerline of the alignment face coincides with a vertical centerline of the welding gun body 1. The nozzle circumferentially surrounds the electrically conductive tube (not shown), and a welding wire 5 passes through the electrically conductive tube to reach a welding position.

The first nozzle 2 and the second nozzle 3 are both nozzles made of a structural ceramic material. Specifically, the structural ceramic material is an alumina ceramic material, such as 99 ceramic (I) or 99 ceramic (II) or 99 ceramic (III) or 99 ceramic (IV). Certainly, the structural ceramic material may also be a zirconium oxide material, or other structural ceramic material with better heat-shock resistance, better molding performance, and a suitable cost-performance ratio.

The first nozzle 2 and the second nozzle 3 are mirror images of each other. The first nozzle 2 and the second nozzle 3 may be used interchangeably, and it is sufficient to turn 180° to each other during mounting. In this way, the first nozzle 2 and the second nozzle 3 may share a mold, and thus the processing cost of the nozzle is reduced. Top ends of the first nozzle 2 and the second nozzle 3 abut against a bottom end of the welding gun body 1 by a tenon structure 14. The tenon structure 14 extends in the length direction of the nozzle (as in the direction of the arrow A-A in FIG. 3). The arrangement of the tenon structure 14 may facilitate positioning abutting of the nozzle and the welding gun body 1, and thus it is ensured that the vertical section of the welding gun body 1 coincides with the vertical section of the nozzle after abutting. In addition, by staggering the nozzle and the welding gun body 1, the risk of leakage of a primary shielding gas 4 outwardly at a connection between the welding gun body 1 and the nozzle may be reduced.

Both the first nozzle 2 and the second nozzle 3 are provided with screw-bolt unthreaded holes 12 (in the screw-bolt unthreaded holes 12, screw bolts and inner walls of the screw-bolt unthreaded holes 12 are arranged with a clearance, and the screw bolts are not in contact with the nozzle) and screw-bolt operation holes 13 respectively at two end positions in their respective width directions (e.g., in a direction of an arrow B-B in FIG. 3). The screw-bolt unthreaded holes 12 communicate with the corresponding screw-bolt operation holes 13. A hole diameter of the screw-bolt operation holes 13 is larger than a hole diameter of the screw-bolt unthreaded holes 12. The screw-bolt unthreaded hole 12 in the first nozzle 2 and the screw-bolt unthreaded hole 12 in the second nozzle 3 penetrate upwardly through the first nozzle 2 and the second nozzle 3 respectively. In this way, the screw bolts (not shown) may pass upwardly through the screw-bolt operation holes 13 to enter the screw-bolt unthreaded holes 12 to realize a firm connection between the nozzle and the welding gun body 1, and it may also enable a reliable insulation isolation between the screw bolts made of a metal material and a welded metal base material at two groove side walls, so as to reliably prevent a contact short circuit between heads of the screw bolts and the two welding groove side walls and the generation of a phenomenon of bypass discharge.

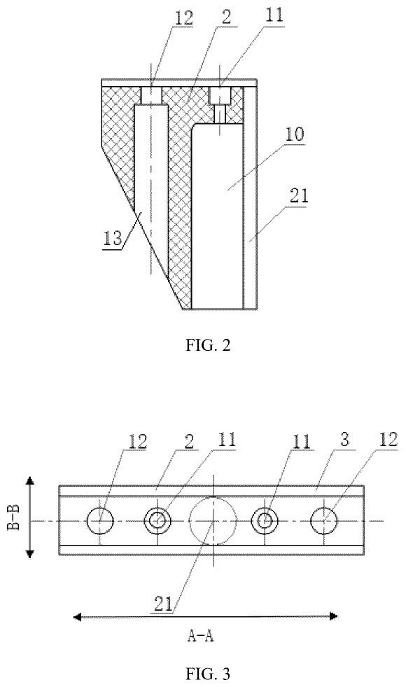

As shown in FIG. 2, the first nozzle 2 and the second nozzle 3 are provided with a first electrically conductive tube cavity 21 and a second electrically conductive tube cavity (not shown) respectively in inner ends (here the inner ends are the mutually aligned and joined ends on the first nozzle 2 and the second nozzle 3). The first electrically conductive tube cavity 21 and the second electrically conductive tube cavity are aligned and joined to form an electrically conductive tube accommodation slot that accommodates the electrically conductive tube (not shown). The electrically conductive tube accommodation slot penetrates through the nozzle along an up-and-down direction and circumferentially surrounds the electrically conductive tube. During assembly, the electrically conductive tube is first mounted to the welding gun body 1, and then the first nozzle 2 and the third nozzle 3 which are of a mirror structure are mounted to a first nozzle fixed coupling position 8 and a second nozzle fixed coupling position 9 on the welding gun body 1 respectively (shown in FIG. 1).

In the embodiment, the vertical section of the bottom end portion of the nozzle is a trapezoidal section.

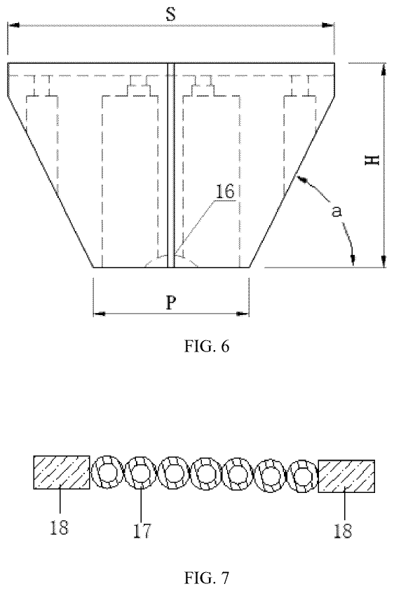

As an implementation, a height H of the nozzle is 23 mm, thicknesses of the first nozzle 2 and the second nozzle 3 are equal and both are 5.8 mm, a length S of a long bottom side of the trapezoidal section is 50 mm, a length P of the short bottom side is 30 mm, and a in FIG. 6 is equal to 39.1 degrees.

As another implementation, the height H of the nozzle is 28 mm, widths of the first nozzle 2 and the second nozzle 3 are equal and both are 7.6 mm, the length S of the long bottom side of the trapezoidal section is 75 mm, the length P of the short bottom side is 36 mm, and a in FIG. 6 is equal to 39.4 degrees.

Certainly, H, S, and P may also be other values, which is not specifically limited here, and may be set according to actual needs.

Since the vertical section of the bottom end portion of the nozzle is the trapezoidal section with a large upper side and a small lower side, the observation of a shape of an arc 6 and a position of a molten pool 7 by human eyes (or by a visual sensor) may be achieved at a large field of view angle on the premise of ensuring that the primary shielding gas 4 protects a high-temperature welding area well.

Obviously, the above embodiments are only examples for clear illustration and are not a limitation of the implementations. For those of ordinary skill in the art, other variations or changes in different forms may further be made on the basis of the above illustration. It is not necessary or possible to exhaust all implementations herein. Obvious variations or changes derived therefrom remain within the scope of protection of the present disclosure.

1. A nozzle for a narrow-gap/ultra-narrow-gap MAG/MIG welding gun, wherein:
a top end of the nozzle is configured to be connected to a bottom end of a welding gun body, and
a vertical section of a bottom end portion of the nozzle is a trapezoidal section with a large upper side and a small lower side.

2. The nozzle for the narrow-gap/ultra-narrow-gap MAG/MIG welding gun according to claim 1, comprising:
a first nozzle; and
a second nozzle, wherein the first nozzle and the second nozzle are aligned and joined together.

3. The nozzle for the narrow-gap/ultra-narrow-gap MAG/MIG welding gun according to claim 2, wherein:
the first nozzle and the second nozzle are provided with a first electrically conductive tube cavity and a second electrically conductive tube cavity, respectively, in respective inner ends thereof,
the first electrically conductive tube cavity and the second electrically conductive tube cavity are aligned and joined to form an electrically conductive tube accommodation slot, and
the electrically conductive tube accommodation slot penetrates through the nozzle along an up-and-down direction.

4. The nozzle for the narrow-gap/ultra-narrow-gap MAG/MIG welding gun according to claim 3, wherein:
a tail end of the nozzle is concave towards a direction of the welding gun body to form a concave area, and
the electrically conductive tube accommodation slot downwardly communicates with the concave area.

5. The nozzle for the narrow-gap/ultra-narrow-gap MAG/MIG welding gun according to claim 1:
wherein:
a height H of the nozzle is 23 mm,
a length S of a long bottom side of the trapezoidal section is 50 mm, and a length P of a short bottom side is 30 mm, or,
wherein:
the height H of the nozzle is 28 mm,
the length S of the long bottom side of the trapezoidal section is 75 mm, and
the length P of the short bottom side is 36 mm.

6. The nozzle for the narrow-gap/ultra-narrow-gap MAG/MIG welding gun according to claim 1, wherein the nozzle is a structural ceramic nozzle.

7. The nozzle for the narrow-gap/ultra-narrow-gap MAG/MIG welding gun according to claim 2, wherein:
a screw-bolt unthreaded hole in the first nozzle and a screw-bolt unthreaded hole in the second nozzle penetrate upwardly through the first nozzle and the second nozzle, respectively, and downwardly communicate with corresponding screw-bolt operation holes, and
a hole diameter of the screw-bolt operation holes is larger than a hole diameter of the screw-bolt unthreaded holes.

8. A narrow-gap/ultra-narrow-gap MAG/MIG welding gun, comprising:
a welding gun body; and
a nozzle, wherein:
a top end of the nozzle is connected to a bottom end of the welding gun body, and
a vertical section of a bottom end portion of the nozzle is a trapezoidal section with a large upper side and a small lower side.

9. The narrow-gap/ultra-narrow-gap MAG/MIG welding gun according to claim 8, further comprising an electrically conductive tube, wherein:
an electrically conductive tube accommodation slot is formed in the nozzle, and
a radial clearance between the electrically conductive tube and a slot wall of the electrically conductive tube accommodation slot is greater than 0.1 mm.

10. The narrow-gap/ultra-narrow-gap MAG/MIG welding gun according to claim 8, wherein the nozzle and the welding gun body are connected together by a tenon structure.
